(19) United States
(12) Patent Application Publication
(10) Pub. No.: US 2010/0042835 A1
(43) Pub. Date: Feb. 18, 2010

(54) SYSTEM AND METHOD FOR PERMISSION CONFIRMATION BY TRANSMITTING A SECURE REQUEST THROUGH A CENTRAL SERVER TO A MOBILE BIOMETRIC DEVICE

(75) Inventors: Andrew Lee, Santa Barbara, CA (US); James Tamplin, Santa Barbara, CA (US)

Correspondence Address: FELIX L. FISCHER, ATTORNEY AT LAW, 1607 MISSION DRIVE, SUITE 204, SOLVANG, CA, 93463, US

(73) Assignee: KEEP SECURITY INC., Santa Barbara, CA (US)

(21) Appl. No.: 12/193,595

(22) Filed: Aug. 18, 2008

(51) Int. Cl. H04L 9/32

(52) U.S. Cl. 713/168

(57) ABSTRACT

A system for permission confirmation incorporates a terminal device for transmitting an authorization request on a network. The terminal device includes capability for encryption of the request and for decryption of a response. A request arbitrating server (RAS) is connected to the network for receiving the authorization request from the terminal device. The RAS incorporates capability for decryption of the request from the terminal display and determines an authorizing party responsive to the request. The RAS then has capability for encryption of a request to an authorizing party for transmission on the network, and, for decryption of a response and biometric data from the authorizing party. The RAS has capability to confirm biometric data received and encrypt a response to the terminal device. A user biometric device (UBD) is connected to the network having capability for receiving an authorization request from the RAS and decrypting the request. A display for the decrypted request and a sensor for entry of biometric data along with an input device for entry of a response to the request is incorporated in the UBD. The UBD provides capability for encrypting the biometric data and response and transmission of the encrypted biometric data and response to the network for receipt by the RAS.

### BACKGROUND OF THE INVENTION

1. Field of the invention

This invention relates generally to the field of electronic transaction verification and more particularly to a system and method for confirmation of permission for a transaction through the use of encrypted communications between a terminal device and a biometric enabled user device through a request arbitrating server.

2. Description of the Related Art

Current methods of seeking authorization from a user for various business transactions generally require that the user sign a document stating the request that is being made, or that the user provide verbal or written authorization through telephone, physical mail, fax, e-mail, or other electronic means. These methods have problems that have been recognized for many years which are only exacerbated by the increase in electronic transactions and electronic authorization of in-store transactions. Acquiring a signature requires that the authorizing party be physically present, or that the signed document be physically delivered. Delivery of documents is expensive and takes time. Determining the validity of a signature is a difficult, inexact, and time-consuming process. Documents can be lost, damaged, tampered with, or destroyed after they are signed. Authorizations that use a fax, telephone, e-mail, or other electronic means are easy to forge. Due to the ease of forgery, authorizations using a fax, telephone, e-mail, or other electronic means are easy to refute. Therefore the authorizing party can falsely deny valid authorizations.

The use of electronic authorization with passwords associated with some form of user identification provide some reduction in the issues presented and are compatible with modern business transactions using personal computers. However, with malicious intrusions on personal computing devices such as Trojans and spyware and the potential for similar compromising of personal communications devices such as smart cellular phones additional security measures are required. U.S. Pat. No. 7,269,737 issued on Sep. 11, 2007 to Robinson entitled System and Method for Biometric Authorization for Financial Transactions resolves certain issues for such authorizations by employing biometric devices for personal identification. However, the potential for piracy of transmitted information is still present and general operability of the system requires modification of current vendor terminal devices for integration of the system.

It is therefore desirable to provide for confirmation of permission for a transaction with increased security and ease of integration with existing equipment in use for networked business transactions.

### SUMMARY OF THE INVENTION

The present invention provides a system for permission confirmation which incorporates a terminal device for transmitting an authorization request on a network. The terminal device includes capability for encryption of the request and for decryption of a response. A request arbitrating server (RAS) is connected to the network for receiving the authorization request from the terminal device. The RAS incorporates capability for decryption of the request from the terminal display and determines an authorizing party responsive to the request. The RAS then has capability for encryption of a request to an authorizing party for transmission on the network, and, for decryption of a response and biometric data from the authorizing party. The RAS has capability to confirm biometric data received and encrypt a response to the terminal device. A uniquely identified user biometric device (UBD) is connected to the network having capability for receiving an authorization request from the RAS and decrypting the request. A display for the decrypted request and a sensor for entry of biometric data along with an input device for entry of a response to the request are incorporated in the UBD. The UBD provides capability for encrypting the biometric data and response and transmission of the encrypted biometric data and response to the network for receipt by the RAS.

### BRIEF DESCRIPTION OF THE DRAWINGS

FIG. 1 is block diagram showing the system elements for a first embodiment of the invention;

FIG. 2A is a method flow chart for the communication interchange between the elements of FIG. 1 for an exemplary transaction;

FIG. 3 is a communications sequence diagram for the elements of the system corresponding to the flow chart of FIG. 2;

FIG. 4 is a block diagram and an alternative integrated embodiment of the User Biometric Device;

FIG. 5 is a flow chart of enrollment and template generation for the User Biometric Device;

FIG. 6 is flow communications sequence diagram for terminal initiation.

### DETAILED DESCRIPTION

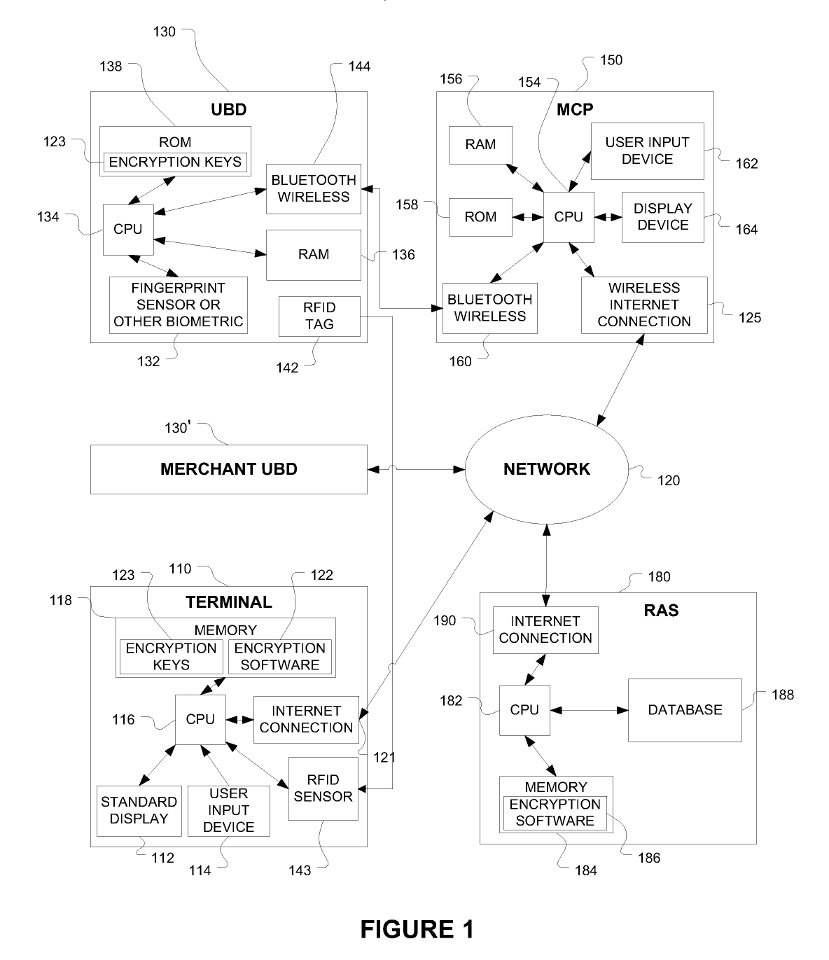

Referring to the drawings, the basic components and the paths of communication for the present invention are shown in FIG. 1. A Terminal Device 110 provides for creating and dispatching authorization requests. The terminal device for the example shown in FIG. 1 provides a graphical user interface (GUI) created by a standard display 112 and associated user input device 114 such as a keyboard. A central processing unit (CPU) 116 with associated memory 118, as contained in a personal computer or present in a computerized cash register or point of sale terminal, is used to provide communications and processing capability for the terminal device. In systems wherein automated transactions occur such as online commerce, the terminal device will be a server not requiring operator interaction and therefore no user interface will be present.

For transactions requiring authorization using the present invention, the terminal device is initiated or enrolled through the network 120 as will be described in greater detail subsequently and communicates through the network via internet connection interface 121 only with a Request Arbitrating Server (RAS) 180. All communications between the terminal device and the RAS are encrypted using software elements generally identified as 122 including encryption keys 123, typically stored in the memory. In alternative embodiments hardware encryption elements may be employed.

A User Biometric Device (UBD) 130 is used to receive and display authorization requests, collect biometric information from the user, and create and transmit authorization request responses back to the RAS. The UBD in its function for approving authorization requests communicates only with the RAS. All communications between the UBD and the RAS are also encrypted. The UBD incorporates one or more biometric sensors 132 to provide biometric data. The biometric data could include fingerprints, voice recognition, retinal scanning, iris measurement, scent, vein patterns, facial recognition, bone structure, DNA, electrocardiogram, hand geometry, behavioral recognition, such as how someone types on a keyboard (as in timing and key pressure), or the gait of their walk or other data unique to an individual provided by sensor systems incorporated in the UBD. A central processing unit (CPU) 134 and associated random access memory 136 provide computation and control capability for the UBD. A read only memory (ROM) 138 is incorporated for communication with the CPU and includes encryption keys generally identified as 140 supplied with and specific to each individual UBD. Each UBD employs a specific identification number such as a device serial number which is employed in transactions as will be discussed in greater detail subsequently. The device serial number may be incorporated in the ROM data for access by the CPU during transaction processing. A radio frequency identification chip (RFID) 142 incorporating the device serial number for short range sampling by, for example, an RFID sensor 143 in the terminal device, may be also provided in certain embodiments of the UBD to simplify transaction communications.

The UBD in a first embodiment is enabled through the use of a smart cellular phone, personal digital assistant (PDA) or other mobile computing platform (MCP) 150 (generally referred to herein as the MCP) for communication with the RAS. The MCP provides communications capability for the UBD via a wireless internet connection 152 or alternative cellular or other wireless communications protocol. The MCP will also typically employ a CPU 154 with associated RAM 156 and ROM 158 for processing and control capability. The UBD interfaces with the MCP through a BlueTooth® or other wireless interface 144 to a mating interface 160 in the MCP or alternatively through a standard USB connection. For the embodiment shown in FIG. 1, the MCP provides a standard input device 162 such as a keypad/keyboard and display 164 as a GUI for message communication.

The RAS 180 for the embodiment shown has a standard architecture with a CPU 182 having an associated memory 184 for operation and database storage 188. As with the terminal device and UBD, the RAS employs software encryption generally identified as 186 in association with the memory. The RAS is connected to the network through an internet connection 190. The RAS processes, relays, and records all authorization requests and authorization replies. In exemplary embodiments, the RAS will encrypt/decrypt transactions both from the terminal and the UBD, record all transaction requests received from terminal devices (such as what the request was, who sent it, and the time of receipt). The RAS will compare biometric data received from the UBD against a template to validate the UBD communications and associated instructions/input from the user. An exemplary biometric comparison technology for fingerprints is the minutiae comparison software available from UPEK, Inc. The RAS will record the response received from the UBD, whether the user accepted or rejected it, the time it was received, and in certain embodiments for record retention, the biometric data itself. The server will communicate with one or more terminal devices and one or more UBDs over the common network 120. Communication to and from the RAS and terminal device as well as the UBD is encrypted to assure that the communications cannot be intercepted and compromised.

In the exemplary embodiment, symmetric key encryption is employed for all communications between the terminal device and RAS, and between the RAS and the UBD. Advanced Encryption Standard (AES) is used in a current embodiment. A public key system is used for establishing symmetric encryption keys on the terminal devices. A system such as that disclosed in U.S. Pat. No. 4,405,829 entitled Cryptographic Communications System and Method issued on Sep. 20, 1983 to Ronald L. Rivest, Adi Shamir, Leonard M. Adleman (known generically as “RSA”) is specifically used for the exemplary embodiment, but other equivalent systems may be employed in alternate embodiments. For the embodiment described herein, the UBD will be provided with encryption keys already installed as previously described. Communications by the RAS with each terminal and with each UBD will be done with a separate, unique AES encryption key, to preclude unauthorized interception of data. In addition, if one key is cracked, a hacker can at most read the communications with one device. Processing requirements for the RAS are not very high and are further limited by solely verifying that the biometric identity information presented by the UBD matches a stored template. As will be described in detail subsequently, the extraction of a template will be done by the UBD, thereby limiting the task of the RAS to the comparison.

Operation of the embodiment of the invention described herein employs an initialization of both the terminal and UBD devices including an enrollment with the RSA for secure operation as will be described in greater detail subsequently. Terminal initiation may only be accomplished by a UBD holder wherein the UBD has been authorized by the RAS for identification. As shown in FIG. 1 the merchant UBD 130′ has a structure and communicates with the RAS in a manner substantially identical to the user UBD, previously described, and is enrolled/verified in a similar manner as described subsequently. The structure and operation of a merchant UBD and a commercial user UBD are substantially identical in providing a verifiable authorization of permission for the functions authorized for that UBD.

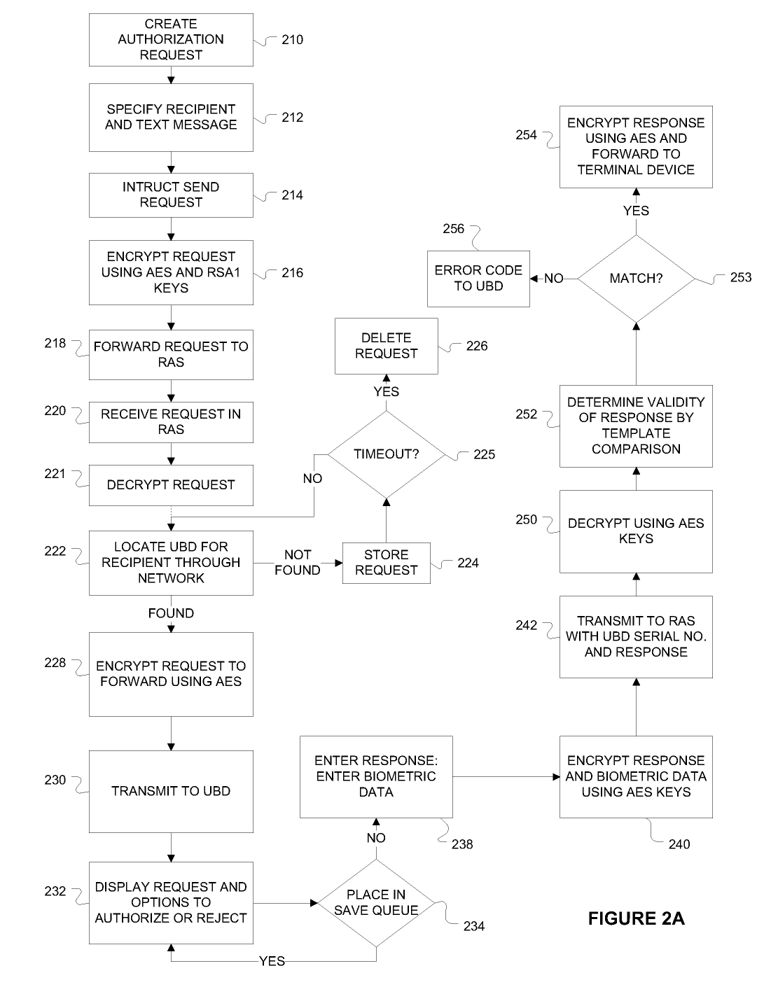

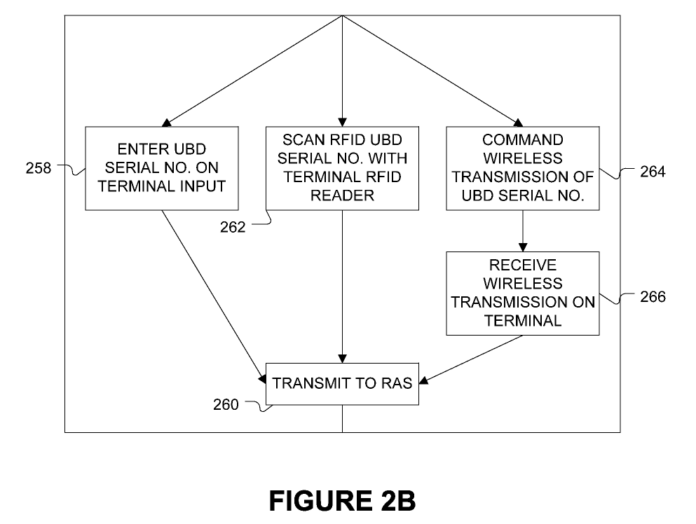

To request an authorization as shown in FIG. 2A, a requesting party must create an authorization request on the terminal device 210. An authorization request must specify a recipient 212. In addition, the request may include a text message as well as images or other data depending on the type of transaction or interchange for which the request is generated. Some requests, such as a request for payment, may not include a text message but merely a payment or debit amount. Once the request has been created, the requesting party must then instruct the terminal device to send the request to the RAS 214. The terminal device will encrypt the request using the unique encryption keys established for the terminal 216 and forward it to the RAS 218.

The RAS acts as a clearinghouse for transaction requests. Once the server receives a transaction request 220, it will decrypt the request 221 and attempt to locate a UBD for the specified recipient 222. In alternative embodiments, the UBD when activated logs on to the internet and the RAS opens a network socket to the device to store the IP address and port number of the UBD for future use or employing cellular network technology a standard presence search is conducted to identify the presence on the network of the UBD. If presence of the recipient on the network is not found, the server may store the request 224 until the presence of a UBD for the recipient has been identified or for a predetermined time 225, or the server may discard the request 226. This choice will be made based on the type of request. If the request requires an immediate response, such as if it is a request for payment at a physical store, then there is no point in storing the request and it will be discarded if the UBD cannot be found. If the request will have meaning even if it is not processed immediately, such as a request to renew a magazine subscription, then it will be saved and transmitted to the UBD the next time it connects to the RAS. This determination will be made by the RAS based on who the terminal device belongs to (different merchants will have permissions to send different types of requests) and on the content of the request itself. If the UBD for the recipient is present on the network, then the server will encrypt a request message 228 and transmit it to the UBD 230.

The UBD will decrypt and display the request to the user and then prompt for user authorization 232. The user then has the option to choose either to authorize or reject the request, or users to have the ability to request additional information. Additional information might include the date and time the request was made, a request identifier number or the terminal device that made the request. In certain embodiments, the user may also place the request in a “save queue” for later action 234. Once a choice is made and entered using the keypad or other entry device, the UBD will prompt input of biometric information 238 and the user will provide biometric information through the UBD to be provided to the RAS. Once biometric information has been entered, the User Biometric Device will encrypt the decision using the unique encryption keys and biometric information 240 and transmit the encrypted data back to the RAS 242.

Once a request response has been received by the RAS from the UBD and decrypted 250, the RAS will determine the validity of the response by comparing the biometric data with a stored template 252. If the biometric data matches the template 253, then the response (authorize or reject) will be encrypted and sent back to the terminal device that originally made the request 254. If the biometric data does not match the template, then an error code will be sent to the UBD 256. If a positive compare is not received, a prompt for re-entry of the biometric data may be presented. Multiple comparison failures may be employed to disable the UBD and/or lock the user account on the RAS to identify the unauthorized approval attempt.

As shown in FIG. 2B, specifying the recipient for the authorization request may take several forms based on the alternate embodiments of the UBD and the terminal device. The user may enter on the terminal input device the device serial number of the UBD, which for exemplary embodiments may be displayed on the UBD display or physically imprinted on the UBD case, or read the number to the merchant for entry, as shown in step 258. The device serial number is then transmitted to the RAS 260. A UBD employing an RFID chip containing the unique device serial number can be scanned 262 by a RFID reader in the terminal device. The device serial number is then forwarded by the terminal device to the RAS to identify the recipient. Alternatively, for a UBD containing the device serial number in the ROM, upon command from the user 264 the UBD CPU may transmit the device serial number via the wireless communications interface for reception by a mating wireless communications interface in the terminal device 266. The device serial number is then forwarded by the terminal device to the RAS.

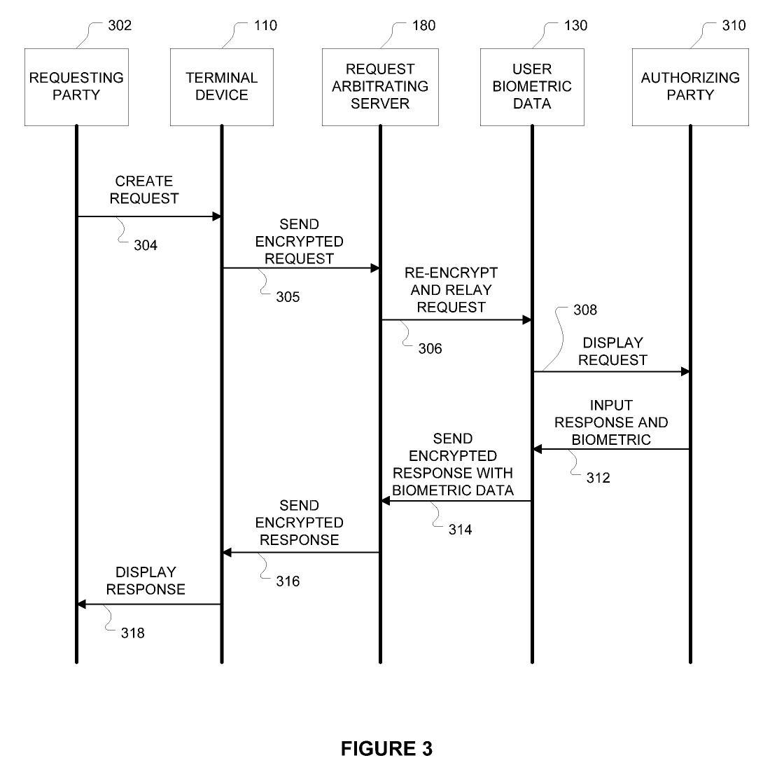

FIG. 3 shows the communications flow between the system elements. The requesting party 302 creates the request 304 typically by key stroke or touch screen input on the terminal device 110. The terminal device sends the encrypted request 305 to the RAS 180 which re-encrypts and relays the request 306 to the UBD 130. The UBD displays the request 308 to the authorizing party 310. The authorizing party then inputs the response (accept/decline) and the biometric data 312 to the UBD. The UBD then sends the encrypted response with the biometric data 314 to the RAS which then sends an encrypted response 316 to the terminal device. The terminal device then displays the response 318 for the requesting party.

The terminal device and UBD include software for encryption/decryption, as previously described with respect to FIG. 1, for communication with the RAS over the network using the AES keys as previously described The RAS includes encryption/decryption for communication with the terminal device and communication with the UBD using AES. The encryption/decryption systems in the exemplary embodiment have common hardware components and merely employ separate encryption keys, as described above, for communications between the other system elements to assure segregation of communications. The terminal device includes separate software for encryption and decryption of RSA for communication with the RAS during AES key exchange. The RAS also includes separate software for encryption and decryption for communication with the terminal during AES key exchange. In alternative embodiments, hardware encryption may be employed.

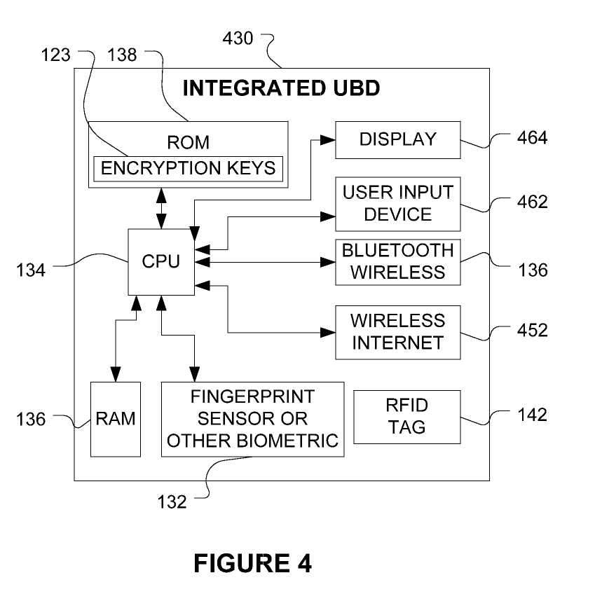

In alternative embodiments, the UBD is a fully integrated system 430 with the cellular/internet communication interface 452, input 462 and display 464 for the GUI as shown in FIG. 4. The functionality of the MCP for communications is incorporated directly into the UBD with internet access provided by cellular, WiFi, satellite or other conventional communications protocols and hardware.

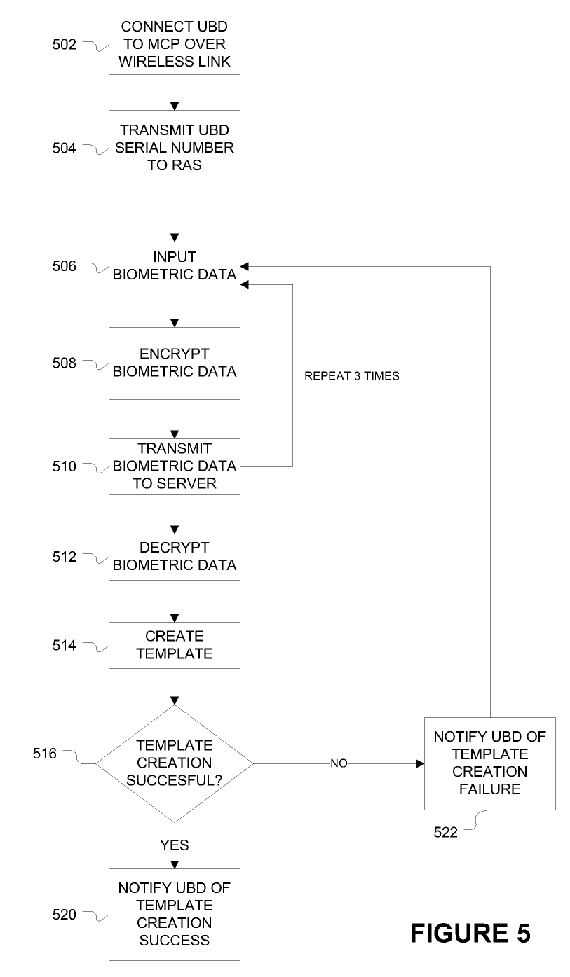

FIG. 5 demonstrates the UBD initiation and template production for use by the system. When a UBD is purchased by a user, the initialization process for the device when powered and connected to the MCP over the wireless link and to the RAS via the MCP internet interface 502 is started by transmission of the UBD serial no. to the RAS 504. Biometric data is then taken 506 through the sensor in the UBD. The biometric data is encrypted 508 and then transmitted to the RAS 510. One or more confirmation inputs are then requested by the UBD from the user to confirm the adequacy of the template. The RAS decrypts the biometric data for each input 512 and creates a template 514. If the biometric data inputs successfully create a template 516 the RAS notifies the UBD and the UBD is registered 520 for use in authorizing transactions. If a successful template was not created, the RAS notifies the UBD 522 and reinput of biometric data is then undertaken.

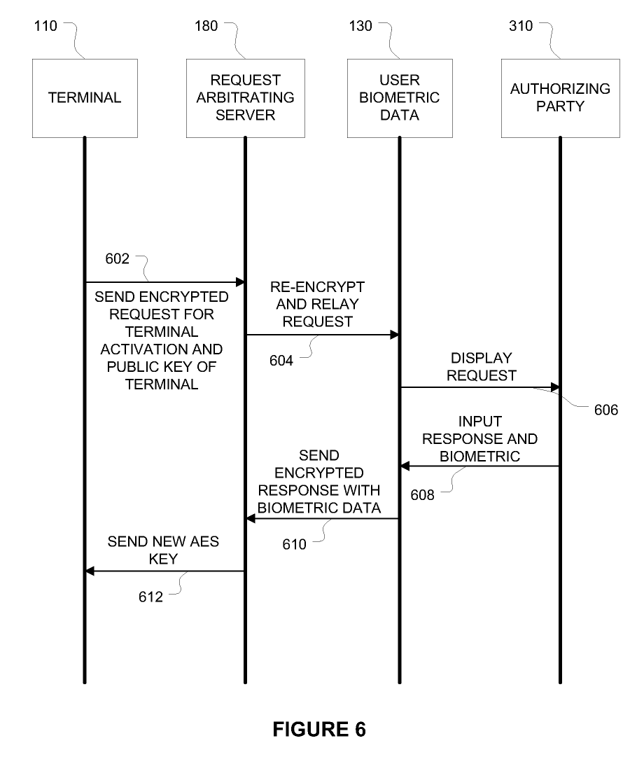

FIG. 6 shows the communication flow for initiation of a terminal for use with the system. For the embodiment described, a software download of the system to a terminal is accomplished. The software download will include the RSA public key of the RAS. After standard installation of the software program by the terminal 110, the terminal generates a new RSA public key for use in AES key exchange with the RAS. The terminal then sends an activation request and the new RSA public key to the RAS 602 employing encryption using the RSA public key of the RAS which was included in the software download. The RAS decrypts the request, stores the RSA public key of the terminal, and re-encrypts and relays the request 604 to the merchant UBD using the AES key stored in and supplied with the UBD. The UBD displays the request 606 to the user. The merchant user upon confirming that the terminal should be enrolled in the system inputs biometric data and the affirmative response (or conversely if the terminal should not be enrolled a negative response) into the UBD 608. The UBD then encrypts and sends the response with the biometric data to the RAS using AES 610. The RAS upon an affirmative response then encrypts a reply message using the RSA key previously generated by the terminal to the terminal supplying a new AES key for subsequent use as an enrolled terminal 612. The terminal device is then operational for entry of authorization requests as previously discussed with respect to FIGS. 2A and 2B.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed as:

1. A system for permission confirmation comprising:
a terminal device for transmitting an authorization request on a network, said terminal device including
means for encryption of the request, and
means for decryption of a response;
a request arbitrating server (RAS) connected to the network for receiving the authorization request from the terminal device, said RAS incorporating
means for decryption of the request from the terminal display,
means for determining an authorizing party responsive to the request,
means for encryption of a request to an authorizing party for transmission on the network, and,
means for decryption of a response and biometric data from the authorizing party,
means for confirmation of the biometric data, and,
means for encryption of the response to the terminal device.
a user biometric device (UBD) connected to the network having
means for receiving an authorization request from the RAS,
means for decryption of the request from the RAS,
means for display of the request to a user responsive to the decryption means,
means for entry of biometric data,
means for entry of a response to the request,
means for encryption of the biometric data and response, and,
means for transmission of the encrypted biometric data and response to the network for receipt by the RAS.

2. The system defined in claim 1 wherein the means for entry of biometric data is a sensor responsive to biometric data selected from the set of fingerprints, voice recognition, retinal scanning, iris measurement, scent, vein patterns, facial recognition, bone structure, DNA, electrocardiogram, hand geometry, behavioral recognition and gait.

3. The system defined in claim 1 further comprising a personal digital assistant (MCP), said MCP incorporating
means for interconnection to the UBD,
means for connection to the network providing the means for receiving an authorization request from the RAS and means for transmission to the network for receipt by the RAS.

4. The system defined in claim 2 wherein the MCP further incorporates a Graphical User Interface and input for providing the means for display of the request and the means for entry of the response.

5. The system defined in claim 1 wherein the UBD further incorporates means for unique identification and the means for determining an authorizing party is responsive to the means for unique identification.

6. The system as defined in claim 5 where in the means for unique identification includes means for wireless transmission of indicia of said unique identification and the terminal device further includes means for receiving the wireless transmission of the indicia.

7. The system of claim 6 wherein the means for wireless transmission comprises an RFID chip and the means for receiving comprises an RFID scanner.

8. A method for permission confirmation comprising the steps of:
using a terminal device for transmitting an authorization request on a network, said terminal device
encrypting the request, and
decrypting a response;
providing a request arbitrating server (RAS) connected to the network for receiving the authorization request from the terminal device,
decrypting the request from the terminal display,
determining an authorizing party responsive to the request,
encrypting a request to an authorizing party for transmission on the network, and,
decrypting a response and biometric data from the authorizing party,
confirming the biometric data, and,
encrypting the response to the terminal device.
providing a user biometric device (UBD) connected to the network and
receiving an authorization request from the RAS,
decrypting the request from the RAS,
displaying the request to a user,
accepting entry of biometric data,
accepting entry of a response to the request,
encrypting the biometric data and response, and,
transmitting the encrypted biometric data and response to the network for receipt by the RAS.

9. The method defined in claim 8 wherein the step of accepting entry of biometric data includes the steps of
providing a fingerprint sensor on the UBD, and
applying a fingerprint to the sensor.

10. The method as defined in claim 8 further comprising the initial steps in providing a UBD of:
initializing the UBD when powered to connect to the RAS through the internet;
providing the biometric input through the sensor in the UBD;
and wherein the step of providing a RAS further comprises the initial steps of:
identifying a new UBD for the network;
querying the UBD for an initial transmission of the biometric data;
receiving the encrypted biometric data;
creating a template in the RAS and storing the template;
associating the template with the UBD for subsequent transaction purposes.

11. The method of claim 8 wherein the step of using a terminal device further includes the preliminary steps of:
downloading system software with initial encryption keys;
sending an encrypted request to the RAS for terminal activation;
re-encrypting and relaying the request in the RAS to a merchant UBD;
displaying the terminal activation request on the merchant UBD;
inputting biometric data and a response on the merchant UBD;
encrypting and sending the biometric data and response to the RAS; and,
sending a new encryption key to the terminal completing activation upon an affirmative response.

12. The method of claim 8 wherein the step of encrypting the request by the terminal device employs a public key system is used for establishing symmetric encryption keys.

13. The method of claim 8 wherein the steps of decrypting the request and encrypting the biometric data and response by the UBD employs a public key system for establishing symmetric encryption keys and the UBD is supplied with a predetermined encryption key.

14. The method of claim 8 wherein the step of using a terminal device for transmitting an authorization request further includes the step of entering a device specific identification number for the UBD.

15. The method of claim 14 wherein the step of entering a device specific identification number for the UBD comprises entering the identification number on an input device in the terminal.

16. The method of claim 14 wherein the step of entering a device specific identification number for the UBD comprises wirelessly transmitting the identification number from the UBD to the terminal device.

17. The method of claim 16 wherein the step of wirelessly transmitting the device specific identification number for the UBD comprises reading an RFID chip on the UBD containing the identification number.
